(19) United States
(12) Patent Application Publication
(10) Pub. No.: US 2026/0128497 A1
(43) Pub. Date: May 7, 2026

(54) ANTENNA ASSEMBLY AND VEHICLE

(71) Applicant: Quectel Wireless Solutions Co., Ltd., Shanghai (CN)

(72) Inventor: Mingjun HANG, Shanghai (CN)

(73) Assignee: Quectel Wireless Solutions Co., Ltd., Shanghai (CN)

(21) Appl. No.: 19/437,602

(22) Filed: Dec. 31, 2025

Related U.S. Application Data
(63) Continuation of application No. PCT/CN2023/139967, filed on Dec. 19, 2023.

(51) Int. Cl. H01Q 1/12; H01Q 5/30; H01Q 9/04

(52) U.S. Cl. CPC H01Q 1/1271; H01Q 5/30; H01Q 9/0428

(57) ABSTRACT

An antenna assembly is applied to a vehicle. The antenna assembly includes: autobody glass including a first glass layer and a second glass layer, a positioning antenna disposed between the first glass layer and the second glass layer, and an autobody metal plate disposed on the side of the second glass layer away from the positioning antenna.

### CROSS-REFERENCE TO RELATED APPLICATIONS

The present application is a continuation of International Application No. PCT/CN2023/139967, filed on December 19, 2023, the content of which is incorporated herein by reference in its entirety.

### TECHNICAL FIELD

The present application relates to the technical field of antennas, in particular to an antenna assembly and a vehicle.

### BACKGROUND

Vehicles rely on a positioning antenna to achieve functions such as satellite positioning and vehicle navigation. In traditional solutions, the positioning antenna is typically disposed inside an antenna box or a shark fin. However, placing the antenna box inside the vehicle subjects the positioning antenna to shielding from the autobody metal and to electromagnetic interference from electrical circuit, thereby weakening the signal reception performance of the positioning antenna. Moreover, the placement of the shark fins can interfere with the design of the panoramic sunroofs, and they are being used less and less in modern vehicle designs. Therefore, the positioning antenna provided by traditional solutions can no longer fully meet the evolving needs of vehicle development.

### SUMMARY

Embodiments of the present application provide an antenna assembly and a vehicle, which are described below in several respects.

In a first aspect, there is provided a positioning antenna assembly applied to a vehicle, the antenna assembly including: an autobody glass, including a first glass layer and a second glass layer; a positioning antenna, disposed between the first glass layer and the second glass layer; and an autobody metal plate, disposed on a side of the second glass layer away from the positioning antenna.

As one possible implementation mode, the autobody glass is sunroof glass of the vehicle, and the autobody metal plate is a roof metal plate.

As one possible implementation mode, the positioning antenna assembly further includes a feed adapter board, disposed outside a coverage area of the autobody glass and connected between the autobody metal plate and the positioning antenna.

As one possible implementation mode, an active circuit is disposed on the feed adapter board.

As one possible implementation mode, the positioning antenna includes a first antenna radiator, corresponding to an L1 frequency band; and a second antenna radiator, corresponding to an L5 frequency band.

As one possible implementation mode, the antenna radiators in the positioning antenna are sheet-like radiators subjected to chamfering treatment.

As one possible implementation mode, the positioning antenna is a diaphragm-like antenna.

As one possible implementation mode, the positioning antenna is a circularly polarized antenna for satellite communication.

As one possible implementation mode, the positioning antenna is a Global Navigation Satellite System (GNSS) antenna.

In a second aspect, a vehicle is provided, which includes the antenna assembly according to any one of the first aspect.

### BRIEF DESCRIPTION OF THE DRAWINGS

FIG. 1 is a schematic diagram illustrating a scenario applicable to the embodiment of the present application.

FIG. 2 is a structural schematic diagram of the positioning antenna assembly according to an embodiment of the present application.

FIG. 3 is a structural schematic diagram of the positioning antenna assembly according to another embodiment of the present application.

FIG. 4 is a structural schematic diagram of the positioning antenna assembly according to yet another embodiment of the present application.

FIG. 5 illustrates the performance parameters of the positioning antenna according to an embodiment of the present application.

FIG. 6 is another schematic diagram showing the performance parameters of the positioning antenna according to an embodiment of the present application.

FIG. 7 is yet another schematic diagram showing the performance parameters of the positioning antenna according to an embodiment of the present application.

FIG. 8 is still another schematic diagram showing the performance parameters of the positioning antenna according to an embodiment of the present application.

FIG. 9 is a further schematic diagram showing the performance parameters of the positioning antenna according to an embodiment of the present application.

FIG. 10 is an additional schematic diagram showing the performance parameters of the positioning antenna according to an embodiment of the present application.

FIG. 11 is a schematic block diagram of a vehicle according to an embodiment of the present application.

### DETAILED DESCRIPTION OF THE EMBODIMENTS

The technical solutions in the present application will be described below in conjunction with the accompanying drawings.

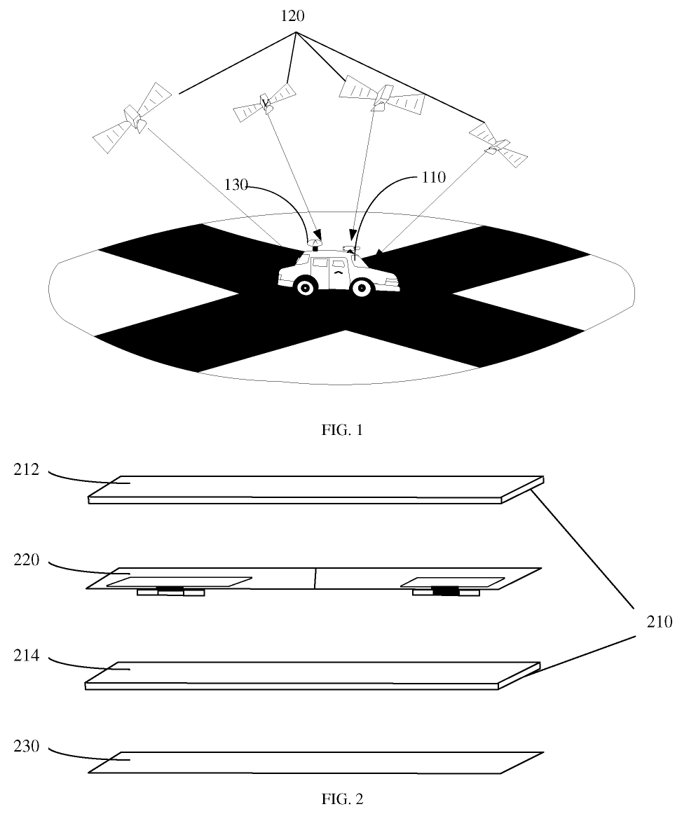

For ease of understanding, a scenario in which embodiments of the present application are applicable is introduced below in connection with FIG. 1. The scenario 100 shown in FIG. 1 may include a vehicle 110, positioning satellites 120, and a positioning antenna 130. Accordingly, the vehicle 110 transmits signals to the positioning satellites 120 or receives signals (hereinafter referred to as transceiving signals) transmitted by the positioning satellites 120 based on the positioning antenna 130 to implement functions such as searching, positioning, and vehicle navigation.

The embodiments of the present application do not impose specific restrictions on the vehicle 110. The vehicle 110 can be any vehicle equipped with a positioning antenna 130. For example, the vehicle 110 can be one of the following passenger vehicles: multi-purpose vehicle (MPV), sport utility vehicle (SUV), sedan, or crossover passenger vehicle. Additionally, the vehicle 110 can also be one of the following commercial vehicles: truck, bus, special-purpose vehicle, or semi-trailer. Alternatively, the vehicle 110 can be a traditional fuel-powered vehicle or a new energy vehicle. Moreover, the vehicle 110 can be a manned vehicle or an unmanned vehicle.

The embodiments of the present application do not impose specific restrictions on the positioning satellite 120. The positioning satellite 120 can be any satellite system capable of transmitting and receiving positioning signals. In other words, the positioning satellite 120 may encompass global satellite systems, regional satellite systems, and augmented satellite systems. For example, the positioning satellite 120 can be satellite systems such as GLONASS, the Global Positioning System (GPS), BeiDou, and Galileo. Collectively, these positioning satellite systems can be referred to as the Global Navigation Satellite System (GNSS).

Different satellite systems correspond to different signal frequency bands. Taking GPS as an example, GPS can operate in the L1 band, L2 band, and L5 band. Specifically, the L1 band has a center frequency of 1575.42 MHz and provides standard positioning and navigation services. The L2 band has a center frequency of 1227.60 MHz and provides high-precision positioning and navigation services. The L5 band has a center frequency of 1176.45 MHz and provides civil precision positioning and navigation services.

The embodiments of the present application do not impose specific restrictions on the positioning antenna 130. The positioning antenna 130 can be any type capable of transmitting and receiving positioning signals. Different satellite systems correspond to different types of positioning antennas. For example, the positioning antenna corresponding to GPS is a GPS antenna, while the positioning antenna for the BeiDou satellite system is a BeiDou antenna. Corresponding to the GNSS mentioned above, the positioning antenna 130 can also be referred to as a GNSS antenna.

The positioning antenna 130 is capable of transmitting and receiving positioning signals across one or more frequency bands. Taking the GPS antenna as an example, corresponding to the L1, L2, and L5 frequency bands mentioned earlier, the GPS antenna can be designed to operate across various frequency bands. For example, the GPS antenna can be a single-frequency band positioning antenna. Alternatively, it can be a dual-frequency band positioning antenna. Furthermore, it can also be a triple-frequency band positioning antenna.

It should be noted that the application scenarios of the solution provided in the embodiments of the present application are not limited to the aforementioned mainstream satellite navigation systems within the current GNSS technology. As technology evolves, other newly emerging GNSS technology implementations also fall within the scope of application scenarios covered by the embodiments of the present application.

In recent years, with the rapid development of Global Positioning System (GPS) technology, it has been widely applied in the automotive sector. Antennas serve as crucial devices for enabling intelligent connected functions such as radio communication, wireless networking, and satellite positioning, playing a pivotal role in transmitting and receiving signals for communication systems. As vehicles continue to advance towards intelligence and connectivity, they are no longer merely products combining mechanical and industrial elements; sometimes, they resemble mobile wireless communication nodes. As the foremost part of the entire communication system, antennas are responsible for positioning and transmitting all position and communication data. Therefore, the performance of antennas directly influences the overall capabilities of intelligent connected vehicle systems.

Vehicles achieve satellite positioning and navigation functions through positioning antennas (also known as GNSS antennas). GNSS antennas can include ceramic-dielectric GNSS circularly polarized antennas and flexible printed circuit (FPC) GNSS linearly polarized antennas. In traditional solutions, ceramic-dielectric GNSS circularly polarized antenna is typically disposed in an antenna box or a shark fin. However, placing the antenna box inside the vehicle can subject the positioning antenna to shielding from the autobody metal and to electromagnetic interference from electrical circuits, thereby weakening the signal reception performance of the positioning antenna. Additionally, the layout of the shark fin can interfere with the design of panoramic sunroofs, leading to their decreasing use in modern vehicle designs. Furthermore, FPC GNSS linearly polarized antennas experience a 3-decibel (dB) signal attenuation when receiving satellite circularly polarized signals, directly impacting the satellite searching and positioning accuracy of the antenna. Therefore, the positioning antennas provided by traditional solutions can no longer fully meet the evolving needs of vehicle development.

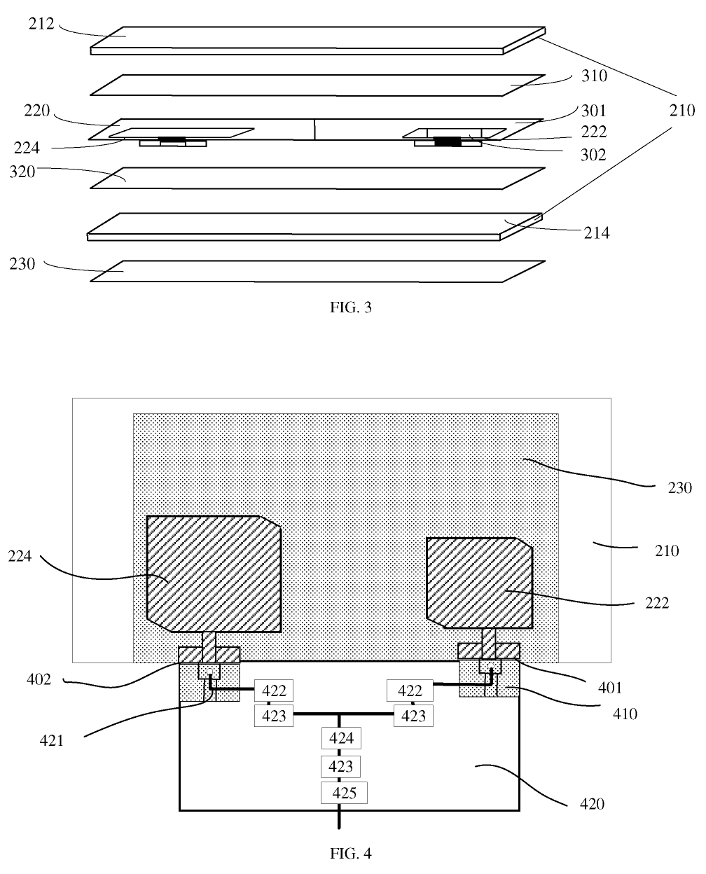

To address the aforementioned problems, in the embodiment of the present application, the positioning antenna assembly disposes the positioning antenna between the laminated layers of the autobody glass and utilizes the autobody metal plate as a reflector. The autobody glass is located on the periphery of the autobody and is far away from the electrical circuit system of the vehicle. Compared with a conventional positioning antenna disposed in an antenna box or a shark fin, the present application can achieve the effect of the positioning antenna being co-formed with the autobody glass without requiring an additional device, and help to prevent electromagnetic interference and metal shielding. The following text will describe the positioning antenna assembly of the embodiments of the present application with reference to FIG. 2.

FIG. 2 illustrates the positioning antenna assembly 200 of an embodiment of the present application. Referring to FIG. 2, the positioning antenna assembly 200 includes an autobody glass 210, a positioning antenna 220, and an autobody metal plate 230.

The autobody glass 210 can be used to fix the positioning antenna 220 at a specific position on the vehicle. It also serves to protect the positioning antenna 220, ensuring stable performance in transmitting and receiving signals. Since the autobody glass 210 is positioned away from the electrical circuit system of the vehicle, it helps prevent electromagnetic interference from the circuit from affecting the positioning antenna 220. Additionally, being located on the periphery of the vehicle, the autobody glass 210 reduces signal shielding of the positioning antenna 220 by the metal autobody.

The autobody glass 210 can consist of two or more layers, with no specific limitation imposed by the embodiments of the present application. As shown in FIG. 2, in some implementation modes, the autobody glass 210 may include a first glass layer 212 and a second glass layer 214, with the positioning antenna 220 disposed between them. Alternatively, in other implementation modes, the autobody glass 210 may have a single glass layer with a cavity in the middle to accommodate the positioning antenna 220.

The autobody glass 210 can be various types of autobody glass. In some implementation modes, the autobody glass 210 can be the sunroof glass of the vehicle. Compared to other autobody glass, the sunroof glass is further away from the electrical circuit, which helps further reduce electromagnetic interference to the positioning antenna 220. Moreover, placing the positioning antenna 220 between the sunroof glass layers orients it towards the sky, further addressing the problem of metal shielding. For example, the positioning antenna 220 can be positioned along the edges of the sunroof glass.

Of course, the autobody glass 210 can also be other types of autobody glass. For example, the autobody glass 210 can be the front windshield. Alternatively, it can be the rear windshield. Furthermore, it can be the side door glass.

The positioning antenna 220 is designed to transmit and receive signals for vehicle positioning and navigation purposes. In other words, the positioning antenna 220 can be a GNSS antenna. For example, a GPS antenna can send received signals to a GPS module, which then analyzes the signals to determine the position of the vehicle.

In some implementation modes, the positioning antenna 220 can be a circularly polarized positioning antenna. A circularly polarized positioning antenna is capable of receiving incoming wave signals of any polarization, and its radiated wave signals can also be received by antennas of any polarization. For these reasons, using a circularly polarized positioning antenna as the positioning antenna 220 helps enhance its signal transmission and reception performance. Of course, the positioning antenna 220 can also be a linearly polarized positioning antenna.

The autobody metal plate 230 can serve as a reflector for the positioning antenna 220, reflecting the signals transmitted by the positioning antenna 220 to one side towards the other side, or redirecting signals that have passed over the positioning antenna 220 back into the range where the positioning antenna 220 can receive them. In other words, by disposing the autobody metal plate 230, the positioning antenna 220 can achieve the function of directional signal transmission and reception. In an embodiment of the present application, utilizing the autobody metal plate 230 as a reflector helps enhance the sensitivity of the antenna in transmitting and receiving signals without requiring an additional device, and also plays a role in blocking and shielding against interference from other signals coming from the rear (opposite direction) of the positioning antenna 220.

The autobody metal plate 230 may correspond to the autobody glass 210. For example, if the autobody glass 210 is the sunroof glass of the vehicle, the autobody metal plate 230 may be a roof metal plate.

In some implementation modes, the autobody metal plate 230 may be disposed on a side of the second glass layer 214 away from the positioning antenna 220. Alternatively, the autobody metal plate 230 may be disposed on a side of the first glass layer 212 away from the positioning antenna 220.

The shape of the autobody metal plate 230 is not particularly limited in this embodiment. For example, the autobody metal plate 230 may be flat. As another example, the autobody metal plate 230 may also be curved.

The material of the autobody metal plate 230 can be any material with signal-reflecting capabilities. In some implementation modes, the material of the autobody metal plate 230 can be aluminum alloy or steel.

Previously, it was mentioned that the positioning antenna 220 can be disposed between the first glass layer 212 and the second glass layer 214. There are various ways to dispose the positioning antenna 220 between the glass layers. For example, a groove can be disposed between the first glass layer 212 and the second glass layer 214, with the positioning antenna 220 fixed within the groove. Alternatively, the positioning antenna 220 can be fixed between the first glass layer 212 and the second glass layer 214 using an adhesive bonding method. Taking the adhesive bonding method as an example, an adhesive film layer can be disposed between the first glass layer 212 and the second glass layer 214, and then the antenna can be fixed either within the film layer or on one side of it, thereby forming a multi-layer structure with the glass layers. Below, a more specific example is provided in conjunction with FIG. 3.

FIG. 3 illustrates a positioning antenna assembly 300 in an embodiment of the present application. Referring to FIG. 3, the positioning antenna assembly 300 may include a first glass layer 212, a first film layer 310, a positioning antenna 220, a second film layer 320, a second glass layer 214, and an autobody metal plate 230.

The first film layer 310 is used to connect the first glass layer 212 with the positioning antenna 220 together. Alternatively, the first film layer 310 is used to bond one side of the positioning antenna 220 to the first glass layer 212.

The second film layer 320 is used to connect the second glass layer 214 with the positioning antenna 220. Alternatively, the second film layer 320 is used to bond the other side of the positioning antenna 220 to the second glass layer 214.

In some implementation modes, the positioning antenna assembly 300 can utilize a vacuum hot-pressing process to thermally bond the first glass layer 212 with the first film layer 310 and the second glass layer 214 with the second film layer 320, thereby positioning the positioning antenna 220 between the first glass layer 212 and the second glass layer 214.

This embodiment of the present application does not impose specific limitations on the first film layer 310, as long as it can connect the first glass layer 212 with the positioning antenna 220. In some implementation modes, the first film layer 310 can be an adhesive layer, which bonds the first glass layer 212 and the positioning antenna 220 together through its adhesive properties. For example, the first film layer can be an ultra violet (UV) adhesive. UV adhesive cures rapidly, helping to enhance the bonding strength between the first glass layer 212 and the positioning antenna 220. Alternatively, the first film layer 310 can also be one of the following adhesive layers: urethanes, silicones, anaerobics, hot melts, etc.

In some implementation modes, the positioning antenna 220 can be structured in a diaphragm-like form. If the autobody glass 210 has a double-layer structure, placing the diaphragm-like positioning antenna 220 between the layers of the autobody glass 210 helps improve the sealing performance of the autobody glass 210.

The positioning antenna 220 is capable of transmitting and receiving signals in one or more frequency bands. In some implementation modes, the positioning antenna 220 can transmit and receive signals in two frequency bands. Adopting a dual-band mode for the positioning antenna 220 helps enhance the flexibility and reliability of positioning. Taking FIG. 4 as an example, FIG. 4 illustrates a positioning antenna assembly 400 in an embodiment of the present application. The positioning antenna 220 may include a first antenna radiator 222 and a second antenna radiator 224, wherein the first antenna radiator 222 and the second antenna radiator 224 correspond to different frequency bands. For example, the first antenna radiator 222 may correspond to the L1 frequency band, while the second antenna radiator 224 may correspond to the L5 frequency band. In other words, the first antenna radiator 222 transmits and receives signals in the L1 frequency band, and the second antenna radiator 224 transmits and receives signals in the L5 frequency band. It should be noted that the first antenna radiator 222 and the second antenna radiator 224 can also correspond to other frequency bands, and this embodiment of the present application does not impose specific limitations in this regard.

In other implementation modes, the positioning antenna 220 can transmit and receive signals in a single frequency band or in a plurality of frequency bands.

This embodiment of the present application does not impose specific limitations on the material of the first antenna radiator 222, as long as it is capable of transmitting and receiving satellite signals. For example, the first antenna radiator 222 can be made of copper foil.

The frequency point of the positioning antenna 220 may be affected by the surrounding environment, especially when it is assembled into a complete device, which may alter the frequency point of the positioning antenna 220. Therefore, it is necessary to adjust the frequency point of the positioning antenna 220 to keep it within the specified frequency band range.

Thus, in some implementation modes, the positioning antenna 220 may include a film layer for adjusting the frequency point of the positioning antenna 220.

For example, as shown in FIG. 3, the positioning antenna 220 may include an antenna diaphragm 301 and a nano-silver layer 302, with the nano-silver layer 302 adhered to the antenna diaphragm 301. By adjusting the thickness and area of the nano-silver layer 302, the frequency point of the positioning antenna 220 can be adjusted, which helps enhance the sensitivity of the positioning antenna 220 in transmitting and receiving signals.

The nano-silver layer 302 can be formed as a diaphragm-like structure on the surface of the antenna diaphragm 301 through a special fabrication process. This special fabrication process may involve physical or chemical fabrication methods, specifically including, but not limited to, the following methods: nano-silver filling by imprinting, atomization, reduction ball milling, evaporation condensation, photochemical reduction, and so on.

The antenna diaphragm 301 can be made of a transparent or semi-transparent substrate. For instance, the antenna diaphragm 301 can be composed of polyethylene terephthalate (PET). Alternatively, the antenna diaphragm 301 may also include materials such as polymethyl methacrylate (PMMA), polystyrene (PS), polycarbonate (PC), and polyethylene (PE), to enhance its hardness and toughness. It is understood that the antenna diaphragm 301 can also be fabricated from any other materials that meet the corresponding functional requirements, and no specific limitations are imposed in this regard.

In some implementation modes, the positioning antenna assembly 300 may also include an active circuit to realize the functionality of an active antenna. The active circuit can be positioned either on the autobody glass 210 or outside the autobody glass 210.

As mentioned earlier, since the positioning antenna 220 is disposed between the layers of the autobody glass, a challenge arises regarding how the active circuit feeds power to the positioning antenna 220. In certain implementation modes, the active circuit can feed power to the positioning antenna 220 via a feed adapter board. Below, a more specific example of the active circuit and the feed adapter board is provided in conjunction with FIG. 4.

Continuing with FIG. 4, the positioning antenna assembly 400 may include an autobody glass 210, a first antenna radiator 222, a second antenna radiator 224, an autobody metal plate 230, a feed adapter board 410, and an active circuit 420.

The active circuit 420 can achieve connection to the positioning antenna 220 through the feed adapter board 410.

As shown in FIG. 4, the feed adaptor board 410 can be disposed outside the covered area of the autobody glass 210 and connected between the autobody metal plate 230 and the positioning antenna 220. Gold fingers can be provided on the feed adaptor board 410. Some of these gold fingers are connected to the first antenna radiator 222 and the second antenna radiator 224, while the others are connected to the autobody metal plate 230. Additionally, the feed adaptor board 410 can be provided with grounding lugs (not shown in the figure), which are connected to the autobody metal plate 230 to enable the autobody metal plate 230 to serve as a reflector for the positioning antenna 220.

There are various types of feed adaptor boards 410. For example, the feed adaptor board 410 can be a Flexible Printed Circuit (FPC) board. Alternatively, it can be a modified polyimide (MPI) flexible board or a liquid crystal polymer (LCP) flexible board. The use of these flexible parts helps ensure the reliability of the connection between the feed adaptor board 410 and the autobody glass 210. Moreover, it also facilitates the adherence of the feed adaptor board 410 to the autobody metal plate 230.

Continuing to refer to FIG. 4, the first antenna radiator 222 is provided with a transition section 401, and the second antenna radiator 224 is provided with a transition section 402. In FIG. 4, the transition section 401 and the transition section 402 are shown as separated structures. Of course, the transition section 401 and the transition section 402 can also be connected together, and no specific limitation is imposed in this regard.

The performance of the positioning antenna 220 can be further enhanced through certain treatments, for example, by adopting the following approaches.

Approach 1: the first antenna radiator 222 can be a sheet-like structure subjected to chamfering treatment. For example, referring to FIG. 4, the top-right and bottom-left corners can be chamfered to adjust the passive performance of the positioning antenna 220, enabling it to become a circularly polarized antenna with a better front-to-back ratio.

Approach 2: the resonant frequency of the positioning antenna 220 can be adjusted by modifying the length and width of the first antenna radiator 222, thereby bringing the voltage standing wave ratio (VSWR) of the positioning antenna 220 closer to 1.

Approach 3: the sensitivity of the positioning antenna 220 in transmitting and receiving signals can be further enhanced by adjusting the distance between the positioning antenna 220 and the autobody metal plate 230.

It should be understood that the aforementioned approaches can be used either individually or in combination, and no specific limitation is imposed in this regard by the embodiments of the present application.

The active circuit 420 can be used to process the signals received by the positioning antenna 220, so as to provide high-quality positioning signals to the next-stage positioning module (not shown in the figure).

In some implementation modes, the active circuit 420 may include a cable 421, a filter 422, an amplifier 423, a combiner 424, and a connector 425.

One end of the cable 421 can be connected to the feed adaptor board 410 to receive signals from the positioning antenna 220 or send signals to it. The other end of the cable 421 is connected to the connector 425, thereby enabling the connection between the positioning antenna assembly 400 and an external positioning module. Devices such as the filter 422, the amplifier 423, and the combiner 424 are connected at the intermediate position along the cable 421.

The filter 422 can be used to filter the received signals, thus removing unwanted frequency components to improve signal quality and suppress interference.

There can be various types of the filter 422, and the embodiments of the present application impose no specific limitations in this regard. For example, the filter 422 can be a Surface Acoustic Wave (SAW) filter. Alternatively, the filter 422 can also be one or more of the following types: a metal cavity filter, a dielectric filter, or a Bulk Acoustic Wave filter.

The amplifier 423 can be used to amplify the signal to a specific power level and then transmit it to the positioning antenna 220 for emission. Alternatively, it can amplify the signal received by the positioning antenna 220 to a specific power level and then transmit it to the positioning module.

The type of the amplifier 423 is not particularly limited by embodiments of the present application. In some implementation modes, the amplifier 423 may be a conduction angle amplifier. Alternatively, the amplifier 423 may also be a “switching” amplifier. For example, the amplifier 423 may be one or more of the following amplifiers: Class A, Class B, Class AB, Class C, Class D, Class F, Class G, Class I, Class S, and Class T amplifiers.

The combiner 424 can be used to combine two or more signals from different frequency bands into a single signal for transmission to the positioning antenna 220, while preventing mutual interference between signals of different frequency bands.

The embodiments of the present application do not impose specific limitations on the type of combiner 424. In some cases, the type of combiner 424 is related to the number of frequency bands received by the positioning antenna 220. For example, if the positioning antenna 220 can receive the L1 and L5 frequency bands, then the combiner 424 can be a dual-channel combiner. Of course, the combiner 424 can also be a triple-channel combiner or a quadruple-channel combiner.

As mentioned above, the connector 425 is connected to the other end of the cable 421, enabling signal reception between the positioning antenna assembly 400 and the positioning module.

The embodiments of the present application do not impose specific limitations on the type of connector 425. For example, the connector 425 can include N-type connector, bayonet nut connector (BNC), subminiature version A (SMA) connector, subminiature version B (SMB) connector, subminiature version C (SMC) connector, and threaded neill–concelman (TNC) connector, and the like.

The above text provides a detailed introduction to the structure of the positioning antenna 220. The performance of the positioning antenna 220 in transmitting and receiving signals can be verified through certain parameters. The performance parameters of the positioning antenna 220 may include gain, voltage standing wave ratio (VSWR), efficiency, and the like. Specifically, the gain is used to measure an antenna’s ability to transmit and receive signals in a specific direction. The higher the gain, the better the directivity and the more concentrated energy. Gain is measured in decibels (dB). Efficiency represents the energy conversion effectiveness, which is the ratio of the antenna’s radiated power to its input power, and its value is always less than 1. VSWR represents the ratio of the maximum to minimum values of the voltage standing wave pattern produced on a lossless transmission line when the antenna is used as its load. A higher VSWR indicates greater reflection and poorer matching.

The following provides an explanation of the performance of the first antenna radiator 222 and the second antenna radiator 224 of the positioning antenna 220 with reference to FIGS. 5 to 10. It should be understood that in FIGS. 5 to 10, the first antenna radiator 222 corresponds to signals in the L1 frequency band, while the second antenna radiator 224 corresponds to signals in the L5 frequency band.

FIG. 5 is a schematic diagram of the VSWR for the first antenna radiator 222. In FIG. 5, the horizontal axis represents the frequency (MHz), and the vertical axis represents the VSWR. Curve L1 is the VSWR curve of the first antenna radiator 222 in the L1 frequency band. Curve S1 is the Smith chart. Curve H1 represents the impedance curve of the first antenna radiator 222 at 1561 MHz (the frequency corresponding to h1). Curve H2 represents the impedance curve of the first antenna radiator 222 at 1575 MHz (the frequency corresponding to h2), and Curve H3 represents the impedance curve of the first antenna radiator 222 at 1602 MHz (the frequency corresponding to h3). As can be seen from FIG. 5, Curve H2 is closest to the matching point on the Smith chart, indicating the best impedance matching at this point. Therefore, the VSWR of the first antenna radiator 222 is minimized at 1575 MHz, reaching a value of 1.3.

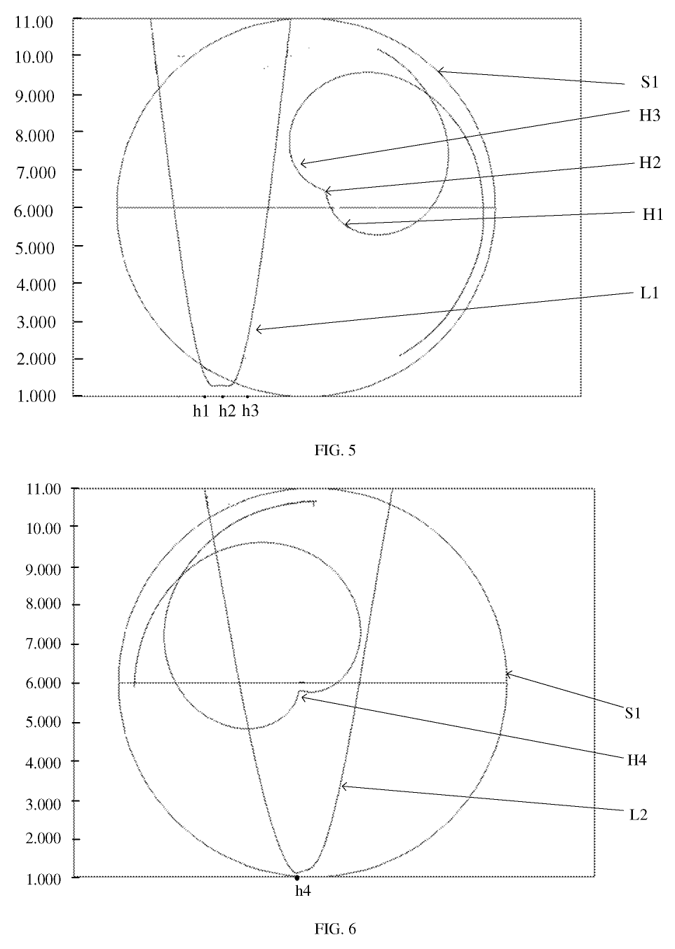

FIG. 6 is a schematic diagram of the VSWR for the second antenna radiator 224. In FIG. 6, the horizontal axis represents the frequency (MHz), and the vertical axis represents the VSWR. Curve L2 is the VSWR curve of the second antenna radiator 224 in the L5 frequency band. Curve S1 is the Smith chart. Curve H4 represents the impedance curve of the second antenna radiator 224 at 1176 MHz (the frequency corresponding to h4). As can be seen from FIG. 6, Curve H4 is closest to the matching point on the Smith chart, indicating the best impedance matching at this point. Therefore, the VSWR of the second antenna radiator 224 is minimized at 1176 MHz, reaching a value of 1.15.

FIG. 7 is a schematic diagram showing the efficiency of the first antenna radiator 222. In FIG. 7, the horizontal axis represents the frequency (MHz), and the vertical axis represents the efficiency (%). As indicated in FIG. 7, the efficiency of the first antenna radiator 222 within the L1 frequency band can reach 38%.

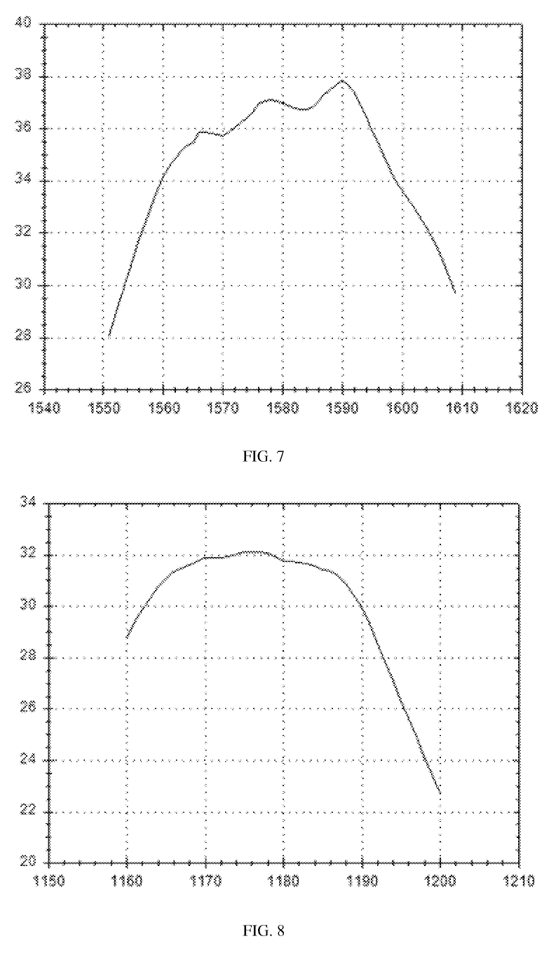

FIG. 8 is a schematic diagram showing the efficiency of the second antenna radiator 224. In FIG. 8, the horizontal axis represents the frequency (MHz), and the vertical axis represents the efficiency (%). As indicated in FIG. 8, the efficiency of the second antenna radiator 224 within the L5 frequency band can reach 32%.

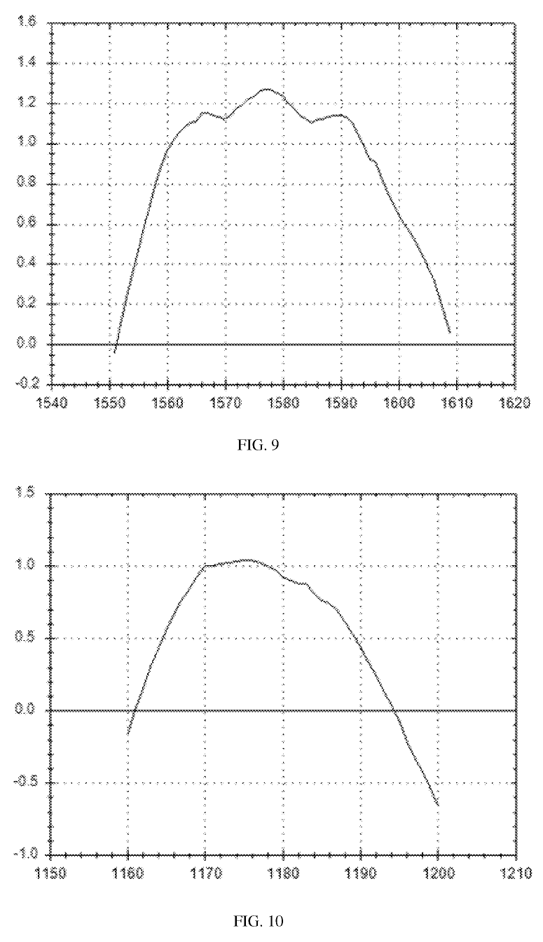

FIG. 9 is a schematic diagram showing the gain of the first antenna radiator 222. In FIG. 9, the horizontal axis represents the frequency (MHz), and the vertical axis represents the gain (dB). As indicated in FIG. 9, the gain of the first antenna radiator 222 within the L1 frequency band can reach 1.3 dB.

FIG. 10 is a schematic diagram showing the gain of the second antenna radiator 224. In FIG. 10, the horizontal axis represents the frequency (MHz), and the vertical axis represents the gain (dB). As indicated in FIG. 10, the gain of the second antenna radiator 224 within the L5 frequency band can reach 1.1 dB.

As can be seen from the above description, the above performance parameters of the first antenna radiator 222 and the second antenna radiator 224 satisfy the usage requirements.

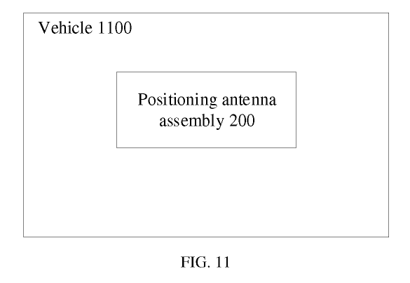

Embodiments of the present application also provide a vehicle, which is described below with reference to FIG. 11.

As shown in FIG. 11, a vehicle 1100 may include the positioning antenna assembly 200 above. Alternatively, the vehicle 1100 may further include the positioning antenna assembly 300 or the positioning antenna assembly 400.

In the embodiments of the present application, the “indication” mentioned can refer to direct indication, indirect indication, or the representation of an associative relationship. For example, when A indicates B, it can mean that A directly indicates B, such as in the case where B can be obtained through A; it can also mean that A indirectly indicates B, for instance, A indicates C and B can be obtained through C; additionally, it can signify that there is an associative relationship between A and B.

In the embodiments of the present application, “B corresponding to A” represents that B is associated with A, and B can be determined based on A. However, it should also be understood that determining B based on A does not imply that B is determined solely based on A; B can also be determined based on A and/or other information.

In the embodiments of the present application, the term “corresponding” may denote a direct or indirect correspondence relationship between two entities, or an associative relationship between them. It may also refer to an indicating-and-indicated relationship, a configuring-and-configured relationship, etc.

The term “and/or” in the embodiments of the present application is only an associative relationship between associated objects, indicating that three possible relationships may exist. For example, A and/or B may represent three scenarios: the presence of A alone, the simultaneous presence of both A and B, or the presence of B alone. Additionally, the character “/” in the text generally indicates that the associated objects before and after it have an “or” relationship.

In the various embodiments of the present application, the size of the sequence numbers of the processes described above does not imply the order of execution. The execution order of the processes should be determined based on their functions and inherent logic, and should not impose any restrictions on the implementation process of the embodiments in the present application.

In the several embodiments provided in the present application, it should be understood that the disclosed systems, apparatuses, and methods can be implemented in other ways. For instance, the apparatus embodiments described above are merely illustrative. For example, the division of units is merely a logical functional division, and there may be alternative ways of division in actual implementation. For example, a plurality of units or components can be combined or integrated into another system, or some features can be omitted or not executed. Additionally, the couplings or direct couplings or communication connections shown or discussed between each other can be indirect couplings or communication connections via some interfaces, devices, or units, which may take electrical, mechanical, or other forms.

The above description is only specific embodiments of the present application, but the protection scope of the present application is not limited thereto, and those skilled in the art can easily conceive variations or substitutions within the technical scope disclosed in the present application, and these should be covered by the protection scope of the present application. Therefore, the protection scope of the present application should be subject to the protection scope of the claims.

What is claimed is:

1. A positioning antenna assembly applied to a vehicle, comprising:
an autobody glass, comprising a first glass layer and a second glass layer;
a positioning antenna, disposed between the first glass layer and the second glass layer; and
an autobody metal plate, disposed on a side of the second glass layer away from the positioning antenna.

2. The antenna assembly according to claim 1, wherein the autobody glass is sunroof glass of the vehicle, and the autobody metal plate is a roof metal plate.

3. The antenna assembly according to claim 1, further comprising:
a feed adapter board, disposed outside a coverage area of the autobody glass and connected between the autobody metal plate and the positioning antenna.

4. The antenna assembly according to claim 3, wherein an active circuit is disposed on the feed adapter board.

5. The antenna assembly according to claim 1, wherein the positioning antenna comprises:
a first antenna radiator, corresponding to an L1 frequency band; and
a second antenna radiator, corresponding to an L5 frequency band.

6. The antenna assembly according to claim 1, wherein an antenna radiator in the positioning antenna is a sheet-like radiator subjected to chamfering treatment.

7. The antenna assembly according to claim 1, wherein the positioning antenna is a diaphragm-like antenna.

8. The antenna assembly according to claim 1, wherein the positioning antenna is a circularly polarized antenna for satellite communication.

9. The antenna assembly according to claim 1, wherein the positioning antenna is a Global Navigation Satellite System (GNSS) antenna.

10. A vehicle, comprising an antenna assembly,
wherein the antenna assembly comprises an autobody glass, a positioning antenna and an autobody metal plate, the autobody glass comprises a first glass layer and a second glass layer, the positioning antenna is disposed between the first glass layer and the second glass layer; and the autobody metal plate is disposed on a side of the second glass layer away from the positioning antenna.

11. The vehicle according to claim 10, wherein the autobody glass is sunroof glass of the vehicle, and the autobody metal plate is a roof metal plate.

12. The vehicle according to claim 10, wherein the antenna assembly further comprises:
a feed adapter board, disposed outside a coverage area of the autobody glass and connected between the autobody metal plate and the positioning antenna.

13. The vehicle according to claim 12, wherein an active circuit is disposed on the feed adapter board.

14. The vehicle according to claim 10, wherein the positioning antenna comprises:
a first antenna radiator, corresponding to an L1 frequency band; and
a second antenna radiator, corresponding to an L5 frequency band.

15. The vehicle according to claim 10, wherein an antenna radiator in the positioning antenna is a sheet-like radiator subjected to chamfering treatment.

16. The vehicle according to claim 10, wherein the positioning antenna is a diaphragm-like antenna.

17. The vehicle according to claim 10, wherein the positioning antenna is a circularly polarized antenna for satellite communication.

18. The vehicle according to claim 10, wherein the positioning antenna is a Global Navigation Satellite System (GNSS) antenna.
